(19) United States
(12) Patent Application Publication
(10) Pub. No.: US 2003/0188533 A1
(43) Pub. Date: Oct. 9, 2003

(54) MOTOR-ASSISTED TURBOCHARGER SYSTEM

(76) Inventor: HEINZ NMN JASTER, SCHENECTADY, NY (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/234,053

(22) Filed: Jan. 19, 1999

(51) Int. Cl. F02D 23/00

(52) U.S. Cl. 60/608

(57) ABSTRACT

A compact, motor-assisted, exhaust-driven turbocharger system is operable to increase the air flow or pressure to an internal combustion engine to reduce engine emissions. The turbocharger system includes a shaft, a expander connected to the shaft and connectable to an exhaust to the engine, and a compressor connected to the shaft and connectable to an air intake of the engine. An electric motor is attachable to the shaft and a controller is connected to electric motor to selectively increase the rotational speed of the exhaust-driven shaft to optimize the air flow or pressure to the engine in response to exhaust emissions, for example, smoke and soot, from the engine or in response to high speed operation of the engine.

### BACKGROUND OF THE INVENTION

This invention relates generally to a turbocharger for an internal combustion engine, and more specifically, to a compact, motor-assisted, exhaust-driven turbocharger system for an internal combustion engine such as a diesel electric locomotive.

FIG. 1 diagrammatically illustrates a prior art turbocharger 10 connected to an internal combustion engine 12 in which exhaust gas from engine 12 is utilized to increase the pressure of air to engine 12. Turbocharger 10 includes a shaft 14, a driving turbine or expander 16 attached at one end of shaft 14, and a compressor 18 attached to the other end of shaft 14. Expander 16 is attached to engine 12 to receive exhaust gases from engine 12 and compressor 18 is attached to an air intake manifold of engine 12.

During operation of turbocharger 10 and engine 12, expander 16 receives exhaust gas that causes turbocharger shaft 14 to rotate, which in turn, causes compressor 18 to rotate and supply air to the air intake manifold of engine 12 at an increased pressure, for example, at a pressure greater than ambient air pressure.

FIG. 2 diagrammatically illustrates another prior art turbocharger 20, often called a turbosupercharger, connected to an internal combustion engine 22 in which a shaft 25 of engine 22 drives a compressor 28 to increase the intake air pressure to engine 12. In particular, compressor 28 is attached to an air intake of engine 22 and to a shaft 24, and shaft 25 of engine 22 is attached to shaft 24 by pulleys 23 and 27, and a belt 29.

While the above-noted prior art turbochargers improve output, power of the engine, a drawback with these types of turbochargers is that they do not reduce emissions at low engine loads or during operation at high altitudes. This is due to the reduced flow of exhaust gas or the reduced speed of the engine shaft during operation at low engine loads and at low ambient air density.

FIGS. 3 and 4 illustrate prior art automotive turbocharger systems that are designed to supplement the operation of a turbocharger during “turbo lag”, the short period of time after increased power demand is first sensed until the rotary compressor driven by the exhaust gas turbine reaches full power capacity.

More specifically, turbocharger 30, diagrammatically illustrated in FIG. 3, is similar to turbocharger 10, described above, with the addition of a separate compressor 31 attached to a shaft 34, which shaft 34 is rotated by a motor 35. During operation of an engine 32 at low power, a check valve 38 closes so that compressor 31 provides pressurized air to compressor 18. Turbocharger 40, diagrammatically illustrated in FIG. 4, is also similar to turbocharger 10, described above, with the addition of a motor 45 attached to shaft 14 for increasing the rotational speed of shaft 14 during operation of an engine 42 at low power. Sensors for monitoring the operation of the turbocharger typically include a throttle sensor, an engine speed sensor, and a power demand sensor.

A drawback with the turbocharger systems shown in FIGS. 3 and 4 is that they are designed to operate to increase the power of the engine and only indirectly reduce emissions from the engine. Another drawback is that the energy of the exhaust gas is not effectively used throughout the operating range of the engine particularly during operation at low power levels. In particular, the rotary compressor, driven by an exhaust gas turbine in the above-described turbocharger and turbocharger systems, is typically designed having a fixed configuration and sized to provide sufficient air for operation at high engine speed and load. A waste gate allows bleeding excess energy in the engine exhaust or pressurized air from the compressor to prevent the engine from being “overcharged.”

Therefore, there is a need for a turbocharger system for an internal combustion engine in which the turbocharger system is compactly configured, uses the energy of the exhaust gas from the engine efficiently, minimizes supplemental energy for assisting the turbocharger, and optimizes the reduction of emissions.

### SUMMARY OF THE INVENTION

A compact, motor-assisted, exhaust-driven turbocharger system is operable to increase the air flow or pressure to an internal combustion engine to reduce engine emissions. The turbocharger system includes a shaft, a expander connected to the shaft and connectable to an exhaust of the engine, and a compressor connected to the shaft and connectable to an air intake of the engine. An electric motor is attachable to the shaft and a controller is operably connected to electric motor to selectively increase the rotational speed of the exhaust-driven shaft to optimize the air flow or pressure to the engine in response to exhaust emissions, for example, smoke and soot, from the engine or in response to high speed operation of the engine.

### BRIEF DESCRIPTION OF THE DRAWINGS

FIG. 1 is a diagrammatic illustration of a prior art turbocharger;

FIG. 2 is a diagrammatic illustration of another prior art turbocharger;

FIG. 3 is a diagrammatic illustration of a prior art turbocharger system;

FIG. 4 is a diagrammatic illustration of another prior art turbocharger system;

FIG. 5 is a diagrammatic illustration of one embodiment of a turbocharger system according to the present invention for an internal combustion engine such as a diesel electric locomotive; and

FIG. 6 is a graph of the percent duty time verses percent fuel rate for a diesel electric locomotive.

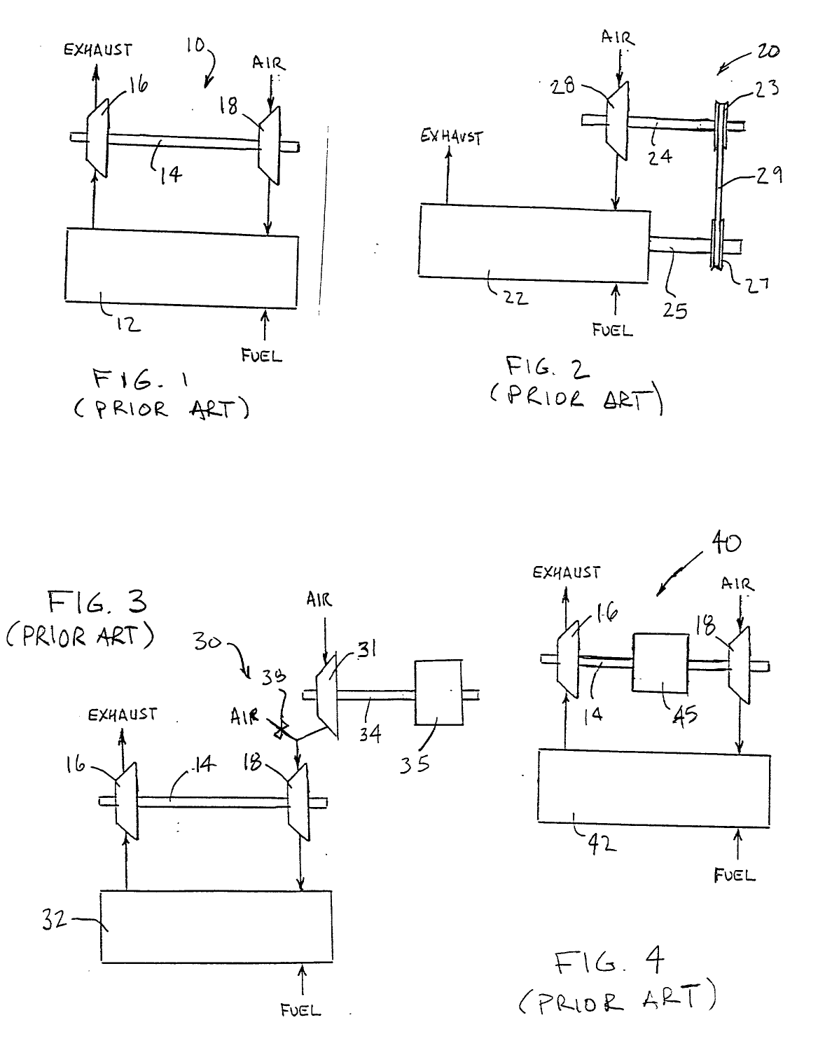

### DETAILED DESCRIPTION OF THE INVENTION

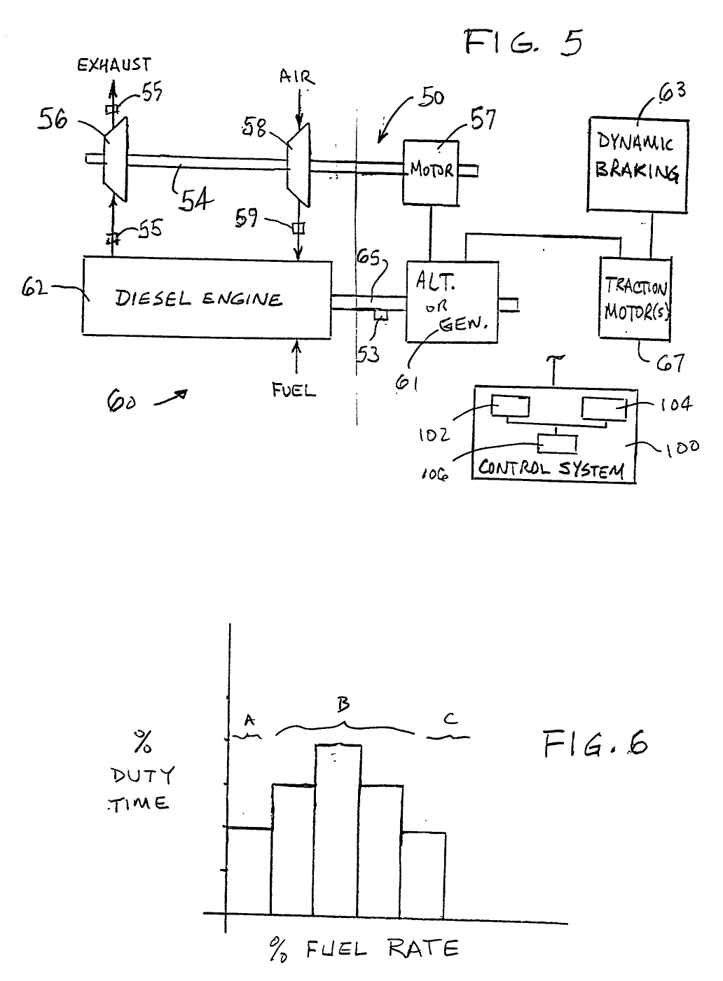

FIG. 5 diagrammatically illustrates a turbocharger system 50 according to the present invention, which system 50 may be incorporated into a power plant system 60 of a diesel electric locomotive. For example, power plant system 60 includes a diesel engine 62 having a drive shaft 65 attached to an alternator or generator 61. Alternator 61 provides electric power to one or more traction motors 67 for propelling a locomotive. Traction motors 67 also generate electrical power, which power can be fed to a dynamic braking grid 63 so that a load is applied to traction motors 67, which load slows or brakes the locomotive.

Exemplary turbocharger system 50 includes a shaft 54 attached at one end to a driving turbine or expander 56 and at the other end to a compressor turbine or compressor 58. Expander 56 is connected to an exhaust outlet of diesel engine 62 and compressor 58 is connected to an air intake of diesel engine 62. An electric motor 57 is attached to shaft 54 and is connected to alternator 61 of power system 60.

From the present description, it will be appreciated by those skilled in the art that electric motor 57 can be attached to one end of the shaft adjacent to compressor 58, attached to shaft 54 between expander 56 and compressor 58, or attached to an end of shaft 54 adjacent to expander 56. It will also be appreciated that the motor may be a hydraulically operated motor, pneumatically operated motor, or other suitable type of motor for assisting in the rotation or increasing the rotational speed of the exhaust-driven turbocharger shaft. In addition, the rotor of the motor need not be integral with the turbocharger shaft but may instead be connected by mechanical devices such as pulleys and belts, a chain or a gear set.

In one aspect of the invention, computing environment or controller 100, for example, a locomotive control system, as described below, is operably connected to sensors for detecting and monitoring exhaust emissions from diesel engine 62 and controlling the motor-assisted operation of turbocharger system 50. The detection and monitoring of exhaust emissions may be either directly or indirectly obtained and either continuously or periodically obtained. For example, an emissions sensor 55 may include a photoelectric sensor, an infrared detector, an electrochemical or catalytic sensor for detecting smoke, soot, combustion gases, combusted gases or oxygen. In addition, one or more emission sensors 55 may be positioned to sense exhaust gas from exhaust manifold of diesel engine 62 before the exhaust gas enters expander 56, exhaust gas in expander 56, or exhaust gas that has passed through expander 56.

In addition, to emissions sensors, additional sensors may be incorporated for monitoring and optimizing the reduction of exhaust emissions, as well as optimizing the diesel engine performance. Such sensors may include an engine speed sensor 53 operably attached to controller 100 for monitoring the speed of engine 62, and an air intake pressure sensor 59 operably attached to controller 100 for monitoring the air intake pressure.

In another aspect of the present invention, desirably expander 56 and compressor 58 have fixed geometries, for example, fixed sizes and fixed vane configurations for pressurizing air to the air intake manifold of diesel engine 62, and are compactly configured for efficiently extracting the energy of the exhaust gases from diesel engine 52 over a broad operating range.

For example, expander 56 and compressor 58 are desirably compactly configured and designed to match a portion of the low and mid speed range of diesel engine 62 so that the energy of the exhaust gases are efficiently utilized and tailored to provide the necessary boosted air pressure for diesel engine 62 without the need for energizing electric motor 57. Where the combination of the expander and compressor alone is not sufficient for providing the necessary pressurized air for operation of diesel engine 62, for example, during startup, at low speed or at substantially maximum rated speed (for example, at low ambient air pressure such as at high altitude), electric motor 57 is readily controlled and energized to increase the speed of shaft 54 thereby increasing the pressure of air supplied to the air intake of diesel engine 62. Desirably, such a configuration efficiently utilizes the energy in the exhaust gases and reduces and minimizes the supply of electric power to motor 57 compared to a situation where the expander receives exhaust that is then bypassed through a waste gate. Advantageously, such turbocharger system having a compact expander, compressor, and motor may be inexpensively and readily manufactured.

In diesel electric locomotives, diesel engine 62 is mechanically decoupled from the drive train, for example, traction motor(s) 67, of the locomotive by means of alternator 61 so that diesel engine 62 does not always operate at design speed. For example, a diesel engine and turbocharger system may be optimized and designed to operate efficiently and at reduced emission levels during operation most likely to be experienced during operation, for example, period B as shown in FIG. 6. Desirably, during periods A and C, which periods are less likely to be experienced but which produce increased emissions, for example, startup, acceleration, low speed operation (downhill or across a level plain), high speed operation (uphill) or at high altitudes, the electric motor turbocharger system 50 of the present invention provides increased air pressure to reduce emissions, for example, smoke and soot, as well as increase power.

One example of controller 100 incorporating and employing the present invention is depicted in FIG. 5. Computing environment 100 includes, for instance, at least one central processing unit 102, a memory or main storage 104, and one or more input/output devices 106. Desirably, computing environment 100 may be provided by a locomotive control system or a single system environment or multiple system environment running an operating system. The invention is not limited to such an environment, however, as the capabilities of the present invention can be incorporated and used within many types of computer environments and many types of computer systems.

Central processing unit 102 is the controlling center and provides the sequencing and processing facilities for instruction execution, interruption action, timing functions, initial program loading and other machine related functions. Central processing unit 102 executes at least one operating system, which operating system is used to control the operation of computing processing unit 102 by controlling the execution of other programs, controlling communication with peripheral devices and controlling use of the computer resources.

Central processing unit 102 is coupled to main storage 104, which main storage 104 is directly addressable and provides for high speed processing of data by central processing unit 102. Main storage may be either physically integrated with the CPU or constructed in stand alone units.

Main storage 104 is also coupled to one or more input/output devices 106. These devices include, for instance, keyboards, communications controllers, teleprocessing devices, devices, printers, magnetic storage media (for example, tape cartridges or disks), optical storage media (for example, CD-ROMs), direct access storage devices, and sensor-based equipment (for example, emissions sensors and engine performance sensors such as those described above). Data is transferred from main storage 104 to input/output devices 106, and from the input/output devices 106 back to main storage 104.

From the present description, computer readable program code for use in computing environment 100 and for implementing the control of motor 57 to optimize the reduction of emissions and power of the diesel engine of the present invention may be readily programmed by those skilled in the art and stored on the above-noted storage media or devices, or imbedded in an integrated circuit. The program code desirably implements comparison of at least one of the emissions from the engine or the high speed operation of the engine to at least one predetermined engine parameter for controlling the electric motor.

While only certain features of the invention have been illustrated and described, many modifications and changes will occur to those skilled in the art. It is, therefore, to be understood that the appended claims are intended to cover all such modifications and changes as fall within the true spirit of the invention.

What is claimed is:

1. A turbocharger system for an internal combustion engine, said turbocharger system comprising:
a rotatable shaft;
an expander connected to said shaft and connectable to an exhaust of said engine;
a compressor connected to said shaft and connectable to an air intake of said engine;
a motor attachable to said shaft;
a controller connected to said motor to selectively energize said motor to rotate said shaft in response to at least one of emissions from the engine or high speed operation of the engine.

2. The turbocharger system according to claim 1, further comprising an emission sensor operably attached to said controller for sensing emissions from the engine.

3. The turbocharger system according to claim 2, wherein said emission sensor comprises a photoelectric sensor

4. The turbocharger system according to claim 2, wherein said emission sensor comprises an electrochemical sensor.

5. The turbocharger system according to claim 1, wherein said expander and said compressor have fixed geometries.

6. The turbocharger system according to claim 1, further comprising a speed sensor attached to said controller for monitoring the speed of said engine.

7. The turbocharger system according to claim 1, wherein said controller is operable to selectively energize said motor in response to air intake pressure.

8. The turbocharger system according to claim 1, wherein said engine comprises a portion of a power plant system of a diesel electric locomotive, and said motor is an electric motor.

9. The turbocharger system according to claim 8, wherein said power plant system comprises an alternator for providing electrical power to said electric motor and to a traction motor for propelling said locomotive.

10. An apparatus for controlling a motor-assisted, exhaust-driven turbocharger system for an internal combustion engine, said apparatus comprising:
a controller adapted to monitor at least one of emissions from the engine or high speed operation of the engine; and
said controller is adapted to selectively energize a motor connected to rotate a shaft of said turbocharger in response to said at least one of emissions from the engine or high speed operation of the engine.

11. An apparatus for controlling a motor-assisted, exhaust-driven turbocharger system for an internal combustion engine, said apparatus comprising:
means for monitoring at least one of emissions from said engine and high speed operation of said engine; and
means for selectively energizing a motor connected to rotate a shaft of said turbocharger in response to said at least one of emissions from said engine or high speed operation of said engine.

12. A method for controlling a motor-assisted, exhaust-driven turbocharger system for an internal combustion engine, said method comprising the steps of:
monitoring at least one of emissions from the engine or high speed operation of the engine; and
selectively energizing a motor operably connected to rotate a shaft of said turbocharger system in response to said at least one of emissions from the engine or high speed operation of the engine.

13. The method according to claim 12, wherein said method further comprises the step of comparing said at least one of the emissions from the engine or high speed operation of the engine to at least one predetermined engine parameter.

14. An article of manufacture comprising:
at least one computer usable medium having computer readable program code embodied therein for controlling a motor-assisted, exhaust-driven turbocharger system for an internal combustion engine, the computer readable program code in said article of manufacture comprising:
computer readable program code for monitoring at least one of emissions from the engine or high speed operation of said engine; and
computer readable program for selectively energizing a motor connected to rotate a shaft of said turbocharger system in response to said at least one of emissions from the engine or high speed operation of the engine.

15. At least one program storage device readable by a machine, tangibly embodying at least one program of instructions executable by said machine to perform a method for controlling a motor-assisted, exhaust-driven turbocharger system for an internal combustion engine, said method comprising;
monitoring at least one of emissions from the engine or high speed operation of said engine; and
selectively energizing a motor connected to rotate a shaft of said turbocharger system in response to said at least one of emissions from the engine or high speed operation of the engine.
